(19) United States
(12) Patent Application Publication
(10) Pub. No.: US 2020/0143203 A1
(43) Pub. Date: May 7, 2020

(54) Method for Design and Optimization of Convolutional Neural Networks

(71) Applicant: Stephen D. Liang, Irving, TX (US)

(72) Inventor: Stephen D. Liang, Irving, TX (US)

(21) Appl. No.: 16/177,558

(22) Filed: Nov. 1, 2018

(51) Int. Cl. G06K 9/62; G06N 3/08; G06N 3/04

(52) U.S. Cl. CPC G06K 9/6262; G06N 3/0445; G06N 3/08

(57) ABSTRACT

The deep Convolutional Neural Networks (CNN) has vast amount of parameters, especially in the Fully Connected (FC) layers, which has become a bottleneck for real-time sensing where processing latency is high due to computational cost. In this invention, we propose to optimize the FC layers in CNN for real-time sensing via making it much slimmer. We derive a CNN Design and Optimization Theorem for FC layers from information theory point of view. The optimization criteria is eigenvalues-based, so we apply Singular Value Decomposition (SVD) to find the maximal eigenvalues and QR to identify the corresponding columns in FC layer. Further, we propose Efficient Weights for CNN Design Theorem, and show that weights with colored Gaussian are much more efficient than those with white Gaussian. We evaluate our optimization approach to AlexNet and apply the slimmer CNN to ImageNet classification. Testing results show our approach performs much better than random dropout.

### BACKGROUND OF THE INVENTION

### Field of the Invention

The field of this invention is in artificial intelligence, more specifically neural networks.

The present invention relates to convolutional neural networks and more particularly to a method for design and optimization of convolutional neural networks.

In other words, the basic types of things that the invention improves or is implemented relates to more efficient convolutional neural networks via reducing the redundancy in the fully connected layers in convolutional neural networks.

### Discussion of the Background

Deep Convolutional Neural Networks has made great success in computer vision, unmanned vehicle systems, AlphaGo Zero, etc. For example, AlexNet [ [symbol] ] made Convolutional Neural Networks (CNN) achieve very promising performance with a top 5 test error rate of 15.4%, and won the 2012 ImageNet Large-Scale Visual Recognition Challenge (ILSVRC). AlexNet has 7 hidden layers (with 5 convolutional layers and 2 fully connected (FC) layers) and 1 FC layer as output layer. Specifically its 5 convolution layers and 3 fully-connected (FC) layers have 650K neurons, 60M parameters, and 630M connections. Given such complexity, it took 5 to 6 days for training on two GTX 580 GPUs. The first FC layer has weights with size 4096×9216, and the second and third FC layers have weights with sizes 4096×4096 and 1000×4096, respectively. Such high dimensional sizes have made the computational speed very slow and implementation cost high, and similar number of weights are used for later CNN models.

Other CNNs have similar large dimensional architecture and their FC layers also have vast amount of weights. ZF Net [ [symbol] ] achieved a top 5 test error rate 11.2% in 2013 ILSVRC, and its structure is almost the same as AlexNet. Its training took 12 days on a GTX 580 GPU. In ZF Net, the first FC layer has weights with size 4096×25088, and the 2nd and 3rd FC layers have the same sizes as those in AlexNet. VGG Net [ [symbol] ] achieved a top 5 error rate of 7.3%, and won the 2014 ILSVRC, and its training was done on 4 Nvidia Titan Black GPUs for around 20 days. The VGG Net has the same number of weights in the FC layers as those in ZF Net. VGG has 3 fully connected layers, and the first FC layer has weights with size 4096×25088. GoogLeNet [ [symbol] ] is a 22 layer (actually 29 layers considering layers without parameters) CNN and achieved a top 5 test error rate of 6.7%. It took roughly one week to do the training on a few high-end GPUs. ResNet [ [symbol] ] could reduce the top 5 error rate to 3.6%. It took 2 to 3 weeks training on an 8 GPU machine. In 2017, SENets [ [symbol] ] squeezed the top-5 error to 2.251%. with training on 8 servers (64 GPUs) in parallelism. All these deep CNNs have common characteristics: 1) a large number of weights are involved in the FC layers, 2) trained with a number of GPUs, 3) took days or weeks for training. It's desirable that optimization schemes could be used to tremendously simplify the CNN, especially to reduce the number of weights in FC layers.

For all real-time applications, we need to make neural network more efficient with less parameters. To make CNN slim, we need to remove or mute certain weights. A prime example of this approach is random projection methods, which select the mapping at random [ [symbol] ]. For example, random dropout in CNN training belongs to this approach [ [symbol] ]. Principal components analysis (PCA) and its refinements could be applied for this optimization. PCA mapping is not pre-determined, but depends on the weights. The PCA algorithm could use the weights to compute the mapping, and the mapping is truly time-varying since the weights are different for different FC layers, so PCA can help to identify the underlying structure of the weights. In [ [symbol] ], a method of PCA based on a new L₁-norm optimization technique is proposed. The proposed L₁-norm optimization technique is intuitive, simple, and easy to implement. It is also proven to find a locally maximal solution. A generalized 2-D principal component analysis by replacing the L₂-norm in conventional 2-D principal component analysis with Lₚ-norm was proposed in [ [symbol] ], both in objective and constraint functions. A cluster-based data analysis framework was proposed in [ [symbol] ] using recursive principal component analysis, which can aggregate the redundant data and detect the outliers in the meantime. Recent advances on PCA in high dimensions are reported in [ [symbol] ]. Singular value decomposition (SVD) or eigenvalue decomposition could be used for PCA [ [symbol] ]. In [ [symbol] ], SVD-QR was applied to data pre-processing of deep learning neural networks, but the structure of neural network was not studied. Recently, information theory has been applied to deep neural networks. Tishby and Zaslaysky [ [symbol] ] proposed to analyze deep neural networks in the Information Plane; Shwartz-Ziv and Tishby [ [symbol] ] further followed up on this idea and demonstrate the effectiveness of the Information Plane visualization of deep CNN. All these works are purely theoretical studies, and didn't provide clear guidelines on the design and optimization criteria for deep CNN. In this invention, we are interested in deriving general design and optimization criteria for deep CNN using information theory, and apply SVD-QR algorithm to make it slim based on the criteria.

### U.S. PATENT DOCUMENTS

The following U.S. patents are on convolutional neural networks, but most of them are on the applications of CNN. U.S. Pat. No. “9,805,305, Boosted deep convolutional neural networks (CNNs)” is on training a collection of multiclass CNNs via a boosting process comprising at least one boost iteration to utilize an auxiliary CNN, but it is not on optimization the structure of CNN.
1 U.S. Pat. No. 10,083,374 Methods and systems for analyzing images in convolutional neural networks.
2 U.S. Pat. No. 10,002,313 Deeply learned convolutional neural networks (CNNS) for object localization and classification.
3 U.S. Pat. No. 9,996,772 Detection of objects in images using region-based convolutional neural networks
4 U.S. Pat. No. 9,965,719 Subcategory-aware convolutional neural networks for object detection
5 U.S. Pat. No. 9,965,705 Systems and methods for attention-based configurable convolutional neural networks (ABC-CNN) for visual question answering
6 U.S. Pat. No. 9,940,573 Superpixel methods for convolutional neural networks
7 U.S. Pat. No. 9,916,531 Accumulator constrained quantization of convolutional neural networks
8 U.S. Pat. No. 9,904,874 Hardware-efficient deep convolutional neural networks
9 U.S. Pat. No. 9,858,484 Systems and methods for determining video feature descriptors based on convolutional neural networks
10 U.S. Pat. No. 9,836,853 Three-dimensional convolutional neural networks for video highlight detection
11 U.S. Pat. No. 9,805,305 Boosted deep convolutional neural networks (CNNs)
12 U.S. Pat. No. 9,785,855 Coarse-to-fine cascade adaptations for license plate recognition with convolutional neural networks
13 U.S. Pat. No. 9,754,351 Systems and methods for processing content using convolutional neural networks
14 U.S. Pat. No. 9,739,783 Convolutional neural networks for cancer diagnosis
15 U.S. Pat. No. 9,697,416 Object detection using cascaded convolutional neural networks.
16 U.S. Pat. No. 9,646,243 Convolutional neural networks using resistive processing unit array.
17 U.S. Pat. No. 9,633,282 Cross-trained convolutional neural networks using multimodal images.
18 U.S. Pat. No. 9,589,374 Computer-aided diagnosis system for medical images using deep convolutional neural networks
19 U.S. Pat. No. 9,563,840 System and method for parallelizing convolutional neural networks
20 U.S. Pat. No. 9,542,626 Augmenting layer-based object detection with deep convolutional neural networks
21 U.S. Pat. No. 9,536,293 Image assessment using deep convolutional neural networks
22 U.S. Pat. No. 9,524,450 Digital image processing using convolutional neural networks
23 U.S. Pat. No. 9,418,458 Graph image representation from convolutional neural networks
24 U.S. Pat. No. 9,418,319 Object detection using cascaded convolutional neural networks
25 U.S. Pat. No. 9,405,960 Face hallucination using convolutional neural networks
26 U.S. Pat. No. 9,286,524 Multi-task deep convolutional neural networks for efficient and robust traffic lane detection
27 U.S. Pat. No. 8,442,927 Dynamically configurable, multi-ported co-processor for convolutional neural networks
28 U.S. Pat. No. 8,345,984 3D convolutional neural networks for automatic human action recognition
29 U.S. Pat. No. 7,747,070 Training convolutional neural networks on graphics processing units

### BRIEF SUMMARY OF THE INVENTION

The above and other needs are addressed by the present invention, which provides CNN Design and Optimization Theorem from information theoretical point of view, and shows two design and optimization criteria, namely, 1) rank criteria: the weight matrix has to be full rank; 2) singular value criteria: the singular values of the selected subset of weight matrix have to be maximized. Further, the present invention shows that FC layer with weights of colored Gaussian is more efficient than that with white Gaussian.

Accordingly, one practical approach of SVD-QR is applied to make CNN slim. The SVD is able to find the maximum singular values, and QR helps to identify which columns are corresponding to these singular values.

Still other aspects, features, and advantages of the present invention are readily apparent from the following detailed description, simply by illustrating using AlexNet (one of the most popular CNNs). The present invention is also capable of other CNNs and different neural networks with large number of weights, and its several details can be modified in various respects, all without departing from the spirit and scope of the present invention. Accordingly, the drawing and description are to be regarded as illustrative in nature, and not as restrictive.

### BRIEF DESCRIPTION OF THE SEVERAL VIEWS OF THE DRAWING

The present invention is illustrated by way of example, and not by way of limitation, in the figures of the accompanying drawings and in which like reference numerals refer to similar elements and in which:

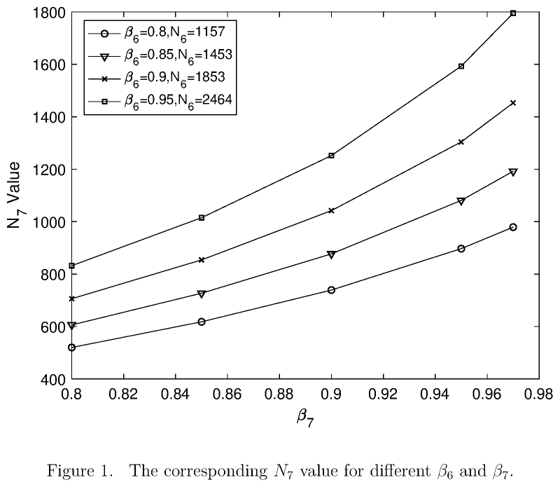

1. FIG. 1. is a graph illustrating the corresponding N₇ value for different β₆, β₇.

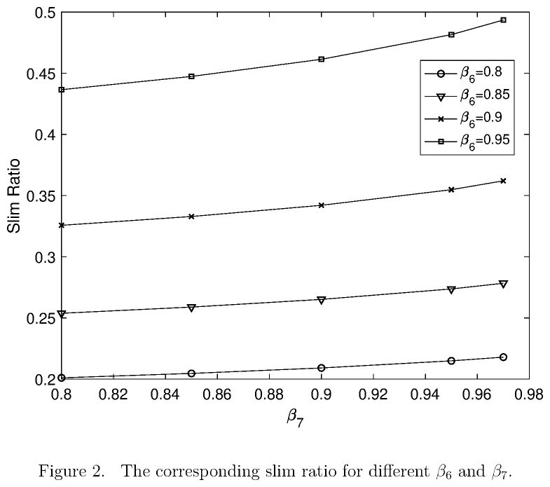

2. FIG. 2. is a graph illustrating the corresponding slim ratio for different β₆ and β₇.

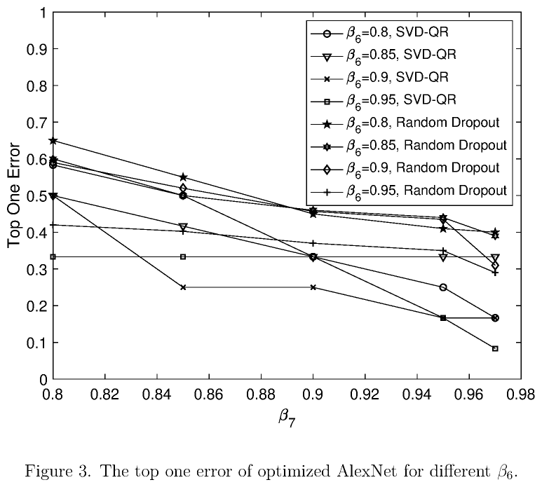

3. FIG. 3. is a graph illustrating the top one error of optimized AlexNet for different β₆.

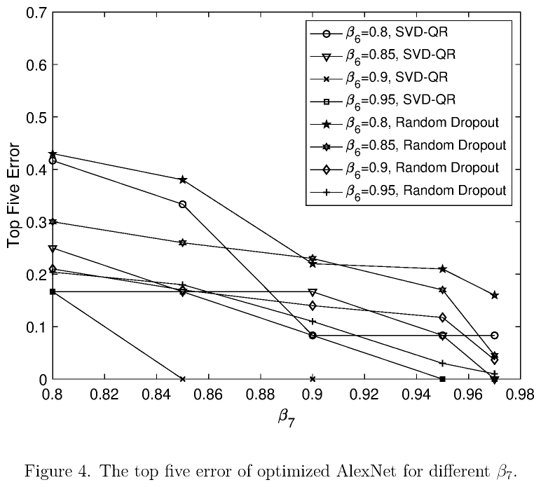

4. FIG. 4. is a graph illustrating the top five error of optimized AlexNet for different β₇.

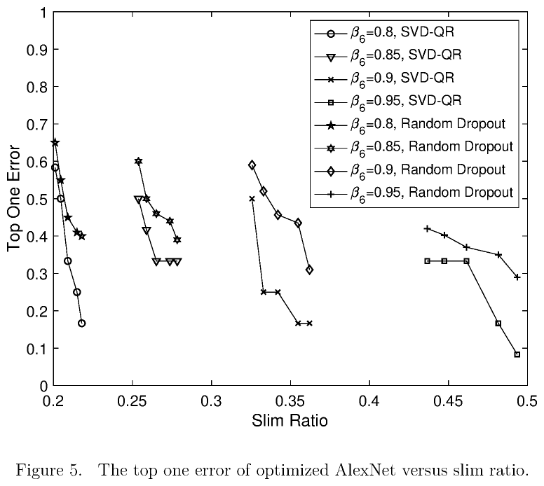

5. FIG. 5. is a graph illustrating the top one error of optimized AlexNet versus slim ratio.

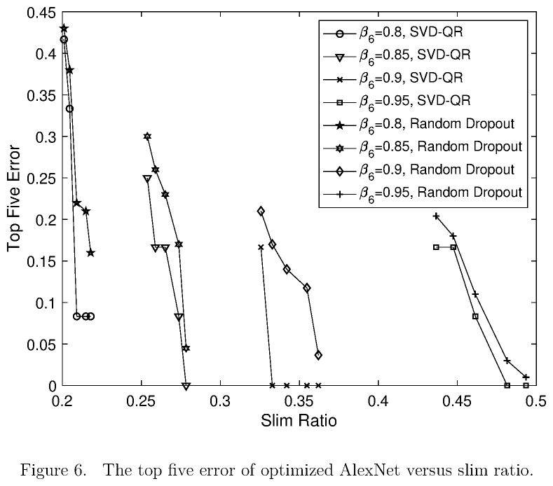

6. FIG. 6. is a graph illustrating the top five error of optimized AlexNet versus slim ratio.

### DETAILED DESCRIPTION OF THE INVENTION

Based on the statistical analysis of weights in FC layers in [18], the weights follow colored Gaussian distribution. In this invention, we try to optimize deep CNN to make it slim via reducing its number of weights in FC layers, from W to Ŵ (with less number of columns). For the benefit of making analysis of optimization process, we can think of removed columns have weights all 0's, so matrix W and Ŵ can have the same size. From this sense, our optimization is very similar to drop out in CNN training. However, this is only for the convenience of analysis, and the removed columns will be deleted in the real computation.

We would like to make general analysis on the weights, and each column in W is samples of Gaussian random variable wᵢ, so W is samples of colored zero-mean Gaussian random vector, w=[w₁, w₂, . . . , wₙ], and its covariance matrix

K=E{w^{t}·w} (1)

where E{·} stands for mathematical expectation. Similarly, Ŵ is samples of random vector ŵ=[ŵ₁,ŵ₂, . . . , ŵₙ]. Let's define

eᵢ [symbol] wᵢ−ŵᵢ (2)

as the residual error between wᵢ and ŵᵢ for i=1, 2, . . . , n.

We make theoretical analysis on the FC layer optimization from information theoretical point of view. Since w is colored Gaussian vector, its entropy is

h(w)=1/2 log(2πe)ⁿ|K| (3)

where e is exponential constant. The distortion between wᵢ and ŵᵢ is

Dᵢ=E{(wᵢ−ŵᵢ)²} (4)

and subject to

$${\sum }_{i = 1}^{n} {D}_{i} \leq D \qquad ( 5 )$$

The rate distortion function is [ [symbol] ] [ [symbol] ]

$$R ( D ) = {min}_{{\sum }_{i = 1}^{n} {D}_{i} \leq D} I ( w , \hat{w} ) \qquad ( 6 )$$

where I(w, ŵ) is the mutual information between w and ŵ. Based on the relations between mutual information and entropy [ [symbol] ]

$$\begin{matrix}I ( w , \hat{w} ) = h ( w ) - h ( w \vert \hat{w} ) ( 7 ) \\ = h ( w ) - h ( w - \hat{w} \vert \hat{w} ) ( 8 ) \\ \geq h ( w ) - h ( w - \hat{w} ) ( 9 ) \\ = h ( w ) - h ( e ) ( 10 )\end{matrix}$$

From (8) to (9) is based on the fact that removing condition increases entropy. Based on the chain rule of h(e),

$$\begin{matrix}I ( w , \hat{w} ) = h ( w ) - {\sum }_{i = 1}^{n} h ( {e}_{i} \vert {e}_{i - 1} , {e}_{i - 2} , … , {e}_{1} ) ( 11 ) \\ \geq h ( w ) - {\sum }_{i = 1}^{n} h ( {e}_{i} ) ( 12 ) \\ = \frac{1}{2} {log ( 2 π e )}^{n} \vert K \vert - {\sum }_{i = 1}^{n} \frac{1}{2} log ( 2 π e ) {D}_{i} ( 13 ) \\ = \frac{1}{2} ( log \vert K \vert - {\sum }_{i = 1}^{n} log {D}_{i} ) ( 14 )\end{matrix}$$

From (11) to (12) is based on the fact that removing condition increases entropy. Rate distortion function measures the efficiency of selected weights. Lower rate is more efficient for given distortion because less number of weights could be used to represent the original weights.
Theorem 1 (CNN Design and Optimization Theorem). In CNN optimization to make FC layers slim, two criteria should be followed: 1) rank criteria. The weight matrix W should be of full rank for optimal design. 2) singular value criteria. The singular values of Ŵ (weight matrix after optimization) should be maximized for given matrix size.
Proof. In CNN optimization, we obtain rate distortion function for given distortion D based on (6) and (14),

$$R ( D ) = {min}_{{\sum }_{i = 1}^{n} {D}_{i} \leq D} \frac{1}{2} ( log \vert K \vert - {\sum }_{i = 1}^{n} log {D}_{i} ) \qquad ( 15 )$$

Since K is the covariance of W, so its determinant will be non-negative. To make log|K| valid, |K| should be non-zero, so |K|>0, which means K is full rank, then W is full rank. The determinant of K equals to the product of its eigenvalues λᵢ [ [symbol] ],

$$\begin{matrix}R ( D ) = {min}_{{\sum }_{i = 1}^{n} {D}_{i} \leq D} \frac{1}{2} ( log {\prod }_{i = 1}^{n} {λ}_{i} - {\sum }_{i = 1}^{n} log {D}_{i} ) ( 16 ) \\ = {min}_{{\sum }_{i = 1}^{n} {D}_{i} \leq D} \frac{1}{2} {\sum }_{i = 1}^{n} log \frac{{λ}_{i}}{{D}_{i}} ( 17 )\end{matrix}$$

Based on (15) and (5), using Lagrange multiplier, we can construct the following function

$$J ( D ) = \frac{1}{2} {\sum }_{i = 1}^{n} log \frac{{λ}_{i}}{{D}_{i}} + α {\sum }_{i = 1}^{n} {D}_{i} \qquad ( 18 )$$

Differentiate it with respect to Dᵢ, and let it equal to 0, then we obtain [19]

$${D}_{i} = \{ \begin{matrix}α & if α < {λ}_{i} \\ {λ}_{i} & if α \geq {λ}_{i}\end{matrix} \qquad ( 19 )$$

where α is chosen so that Σᵢ₌₁ⁿ Dᵢ=D. So we can choose a constant α and only select subset of K with eigenvalues greater than α. The eigenvalues of K are the squares of the singular values of W. If we can find Ŵ which can have maximal singular values, the determinant of K will be maximized.

It's very meaningful to have W full rank. If W isn't full rank, the CNN still works, however some columns (or rows) of W are linearly dependent, and such design is not optimized because the weights are redundant.
Theorem 2 (Efficient Weights for CNN Design). In CNN design, FC layer weights matrix W with colored Gaussian distribution is more efficient than that of white Gaussian.
Proof. Based on Hadamard's inequality [19], for covariance matrix K of weight matrix W

$$\vert K \vert \leq {\prod }_{i = 1}^{n} {K}_{ii} \qquad ( 20 )$$

the equality holds when the distribution is white Gaussian. Based on (15), |K| achieves maximum value when it's white Gaussian distribution, and the rate distortion function value is higher, which is less efficient. So FC layer weights matrix W with colored Gaussian distribution is more efficient. □

This explains why the initial weights in AlexNet were white Gaussian, but they became colored Gaussian after well trained.

We apply Singular Value Decomposition (SVD) to find the maximal singular values of W, and QR to identify the corresponding columns. The SVD-QR for principal columns selection can be summarized as follows.
1. Calculate the SVD [ [symbol] ] of W as

$$W = U [ \begin{matrix}\sum & 0 \\ 0 & 0\end{matrix} ] {V}^{T}$$

and save V, where Σ is a diagonal matrix with values of σ₁≥σ₂≥ . . . , ≥σᵣ (r=rank(W)) in the diagonal positions.
2. If the desired number of columns has been pre-determined, skip this step, directly go to Step 3. Based on the diagonal values of Σ, σ₁,σ₂, . . . , σᵣ (r=rank(W)) and desired percentage of kept eigenvalues β of K, to determine \hat{r}, (\hat{r}≤r), where

$$\begin{matrix}β = \frac{{\sum }_{i = 1}^{r} {λ}_{i}}{{\sum }_{i = 1}^{r} {λ}_{i}} ( 21 ) \\ = \frac{{\sum }_{i = 1}^{r} {σ}_{i}^{2}}{{\sum }_{i = 1}^{r} {σ}_{i}^{2}} ( 22 )\end{matrix}$$

since the eigenvalues of K equal to the squares of singular values of W (i.e., λᵢ=σᵢ²). β stands for the percentage of the kept eigenvalues, and when β=100%, there is no weight reduction. Based on the above analysis on rate distortion function, eigenvalues of K have direct relations with its performance.
3. Based on the desired number of columns to be selected, \hat{r}, partition

$$V = [ \begin{matrix}{V}_{11} & {V}_{12} \\ {V}_{21} & {V}_{22}\end{matrix} ] \qquad ( 23 )$$

where V₁₁∈ [symbol] ^{\hat{r}×\hat{r}}, V₁₂∈ [symbol] ^{\hat{r}×(M-\hat{r})}, V₂₁∈ [symbol] ^{(M-\hat{r})×\hat{r}}, and V₂₂∈ [symbol] ^{(M-\hat{r})×(M-\hat{r})}.

4. Using QR decomposition with column pivoting, determine Π such that

Q^{T}[V₁₁^{T}, V₂₁^{T}]Π=[R₁₁, R₁₂] (24)
where Q is a unitary matrix.
5. The permutation matrix Π is what we are looking for. There is only one 1's in each column (all other values are 0's), and the row position of 1's in that column tells us which columns should be selected in W, which are corresponding to the descending order of the singular values. Since we only need to select a subset, we can choose the first \hat{r} columns, which are the most important output from this FC layer, i.e., input to the next layer.

We ran simulations using ImageNet [ [symbol] ] [ [symbol] ], and selected 12 images, same as that in [ [symbol] ], as listed in the following (the name and index are from ImageNet):
n02123045 tabby, tabby cat
n02113799 standard poodle
n01944390 snail
n02206856 bee
n02408429 water buffalo, water ox, Asiatic buffalo, Bubalus bubalis
n02437616 llama
n02437616 Zebra
n01443537 goldfish, Carassius auratus
n01629819 European fire salamander, Salamandra salamandra
n04099969 rocking chair, rocker
n07749582 lemon

We used the weights from pre-trained AlexNet in MATLAB, and achieved top five error 0, and top one error 8.33%. The top N error means the rate that the CNN does not make the correct classification with its top N predictions. This would serve as a very good baseline for comparison with the optimized CNN. We used the CNN Design and Optimization Theorem to optimize the AlexNet.

In the first experiment, we fixed the number of columns in FC layers first, then chose the weights based on our optimization scheme. In AlexNet, there are three FC layers. FC6 has weights with matrix size 9216×4096 and bias with vector length 4096; FC7 has weights with matrix size 4096×4096 and bias with vector length 4096; and FC8 has weights with size 4096×1000 and bias with vector length 1000, so the total number of parameters is 58631144. For SVD-QR optimization scheme with N₆ and N₇, FC6 has weights with matrix size 9216×N₆ and bias with vector length N₆; FC7 has weights with matrix size N₆×N₇ and bias with vector length N₇; and FC8 has weights with size N₇×1000 and bias with vector length 1000, so the total number of parameters is 9216N₆+N₆+N₆N₇+N₇+1000N₇+1000. Because for the optimized AlexNet, the number of input to FC6 is 9216 and the number of output is N₆ (also consider bias has N₆ elements); FC7 has the number of input N₆ and the number of output N₇ (also plus N₇ biases); and FC8 has the number of input N₇ and the number of output 1000 (for 1000 categories) plus 1000 biases. For example, for N₆=2000, N₇=2000, the total number of parameters will be 24437000, and the slim ratio is

$$\frac{24437000}{58631144} = 41.68 \% .$$

bimilarly, we can obtain the slim ratio for all other values of N₆ and N₇, as summarized in Table 0.1.

We evaluated its classification based on top one error and top five error for the 12 images, as summarized in Table 0.1. We also compared it against random dropout where the weights are randomly selected, for example, in FC6, N₆=2000, then the weights have a matrix size of 9216×2000, and the 2000 columns are randomly selected from the original 4096 columns. To smooth its randomness, we ran Monte Carlo simulations of random dropout for 20 times of each N₆, N₇ value. Random dropout is the most popular method to set weights to zeros to avoid overfitting in CNN training. Observe Table 0.1, our SVD-QR optimization could achieve much better performance in terms of top one error and top five error. It could achieve zero error for N₆=2000 and N₇=2000. In comparison, even using AlexNet (all weights are kept), the Llama (n02437616 llama in ImageNet) was classified wrong with top one error (no top five error), however our SVD-QR-based optimization could achieve top one error 0 when N1=2000 and N₂=2000. This means we could use much less number of weights to achieve better performance than AlexNet. A slimmer CNN could achieve better performance than CNN.

TABLE 0.1
Top five and top one error for our SVD-QR
optimization and random dropout.

| | | | Random Dropout | | SVD-QR | |
|---|---|---|---|---|---|---|
| N₆ | N₇ | Slim Ratio | ϵ₅ | ϵ₁ | ϵ₅ | ϵ₁ |
| 2000 | 2000 | 41.68% | 2% | 27% | 0 | 0 |
| 2000 | 1500 | 38.46% | 6% | 30% | 0 | 20% |
| 2000 | 1000 | 35.95% | 8.89% | 36.67% | 8.33% | 25% |
| 1500 | 2000 | 31.57% | 4% | 26% | 0 | 16.67% |
| 1500 | 1500 | 29.48% | 4.44% | 33.33% | 0 | 16.67% |
| 1500 | 1000 | 27.38% | 10% | 39% | 8.33% | 25% |
| 1000 | 2000 | 22.17% | 6% | 30% | 0 | 25% |
| 1000 | 1500 | 20.49% | 8% | 39% | 8.33% | 16.67% |
| 1000 | 1000 | 18.81% | 18% | 50% | 16.67% | 41.67% |

In the second experiment on AlexNet, we didn't pre-fix the values of N₆ and N₇, but to determine the N₆ and N₇ values based on eigenvalues and β in (22) (β₆ for FC6 and β₇ for FC7). We chose β₆=0.8, 0.85, 0.9,0.95, and for each value of β₆, we used β₇=0.75, 0.8, 0.85, 0.9, 0.95,0.97. In FIG. 1, we summarized β₆, N₆ values, and for each β₇, the corresponding N₇ values were plotted. In FIG. 2, the slim ratio

$$( i . e . , \frac{9216 {N}_{6} + {N}_{6} + {N}_{6} {N}_{7} + {N}_{7} + 1000 {N}_{7} + 1000}{58631144} )$$

was summarized.

We also evaluated the performance of AlexNet in terms of top one error and top five error, as summarized in FIGS. 3. and 4. Observe that when β₆ and β₇ increase, the error decreases in general. But we also observed an abnormal outcome. For example, β₆=0.95, β₇=0.85 had worse performance in top one error and top five error than β₆=0.9, β₇=0.85. Because pre-trained AlexNet may have overfitting to certain training images, and our images may not be in their training domain, so smaller number of weights had better performance. We also compared it against the random dropout approach (with Monte Carlo simulations for 20 times) with exactly the same number of N₆ and N₇ values as that in the SVD-QR. Observe that the SVD-QR approach performs much better than the random dropout, especially when β₆ and β₇ are larger (i.e., N₆ and N₇ are larger, refer to FIG. 1).

We have done two experiments on the optimization of AlexNet based on the optimization criteria we have derived. For different values of β₆ and β₇, we obtained different slim ratio and top one and top five errors. There should be some tradeoff between the slim ratio and error performance. In FIGS. 5. and 6, we plotted slim ratio versus top one error and top five error. At each β₆ value, six β₇ values (0.75, 0.8, 0.85, 0.9, 0.95, 0.97) are listed from top to bottom in the figures. Observe FIG. 5, slim ratio at around 22% (β₆=0.8, β₇=0.97) could achieve top one error at 16%; in FIG. 6, slim ratio at around 28% (β₆=0.85, β₇=0.97) could achieve top five error 0. For comparison, we also plotted the performance for random dropout (with Monte Carlo simulations for 20 times) in FIGS. 5. and 6. Observe that SVD-QR performs much better. With only 28% weights, our slimmer AlexNet with SVD-QR optimization could perform as well as the original AlexNet, which is very impressive.

### BIBLIOGRAPHY

[1] A. Krizhevsky, I. Sutskever, and G. E. Hinton, “ImageNet classification with deep convolutional neural networks,” NIPS 2012: Neural Information Processing Systems, Lake Tahoe, Nev. 1
[2] M. D. Zeiler and R. Fergus, “Visualizing and understanding convolutional network,” European Conference on Computer Vision (ECCV), Zurich, Switzerland, September 2014. 2
[3] K. Simonyan and A. Zisserman, “Very deep convolutional networks for large scale image recognition”, International Conference on Learning Representations (ICLR), San Diego, Calif., May 2015. 2
[4] C. Szegedy et al, “Going deeper with convolutions,” IEEE Conference on Computer Vision and Pattern Recognition (CVPR), Boston, Mass., June 2015. 2
[5] K. He, et al, “Deep residual learning for image recognition,” 2016 IEEE Conference on Computer Vision and Pattern Recognition (CVPR), Las Vegas, Nev., June 2016, 2
[6] J. Hu, et al, “Squeeze-and-excitation networks,” IEEE Conference on Computer Vision and Pattern Recognition (CVPR), Salt Lake City, Utah, June 2018. 2
[7] W. Johnson and J. Lindenstrauss. “Extensions of Lipschitz mappings into a Hilbert space,” Contemporary Mathematics, 26:189-206, 1984. 3
[8] I. Goodfellow, Y. Bengio, and A. Courville, Deep Learning, MIT Press, http://www.deeplearningbook.org, 2016. 3
[9] N. Kwak, “Principal Component Analysis Based on L1-Norm Maximization,” IEEE Transactions on Pattern Analysis and Machine Intelligence, vol. 30, no. 9, pp. 1672-1680, September 2008. 3
[10] J. Wang, “Generalized 2-D Principal Component Analysis by Lp-Norm for Image Analysis,” IEEE Transactions on Cybernetics, vol. 46, no. 3, pp. 792-803, March 2016. 3
[11] T. Yu, X. Wang, and A. Shami, “Recursive Principal Component Analysis-Based Data Outlier Detection and Sensor Data Aggregation in IoT Systems,” IEEE Internet of Things Journal, vol. 4, no. 6, pp. 2207-2216, December 2017. 3
[12] I. M. Johnstone and D. Paul, “PCA in high dimensions: an orientation,” Proceedings of the IEEE(Early Access), pp. 1-16, 2018. 3
[13] H. Abdi and L. J. Williams, “Principal component analysis”, Wiley Interdisciplinary Reviews: Computational Statistics, vol. 2, no. 4, pp. 433-459, 2010. 3
[14] S. D. Liang, “Smart and fast data processing for deep learning in internet of things: less is more,” IEEE Internet of Things Journal, DOI: 10.1109/JIOT.2018.2864579, pp. 1-9, August 2018. 3
[15] N. Tishby and N. Zaslaysky, “Deep learning and the information bottleneck principle,” IEEE Information Theory Workshop (ITW), pp. 1-5, 2015. 3
[16] R. Shwartz-Ziv and N. Tishby, “Opening the black box of deep neural networks via information,” https://arxiv.org/pdf/1703.00810.pdf, April 2017. 3
[17] https://www.mathworks.com/help/deeplearning/ref/alexnet.html
[18] S. D. Liang, “Optimization for Deep Convolutional Neural Networks: How Slim Can It Go?”, IEEE Transactions on Emerging Topics in Computational Intelligence, DOI: 10.1109/TETCI.2018.2876573, pp. 1-9, October 2018. 8, 13
[19] T. Cover and J. Thomas, Elements of Information Theory, 2nd Edition, New York: Wiley, 2006. 9, 11
[20] R. W. Yeung, “Chapter 8, Rate-Distortion Theory,” Information Theory and Network Coding, Springer, Boston, Mass., 2008. 9
[21] G. Strang, Introduction to Linear Algebra, 4th Edition, Wellesley Cambridge Press, Wellesley Mass., 2009. 10
[22] G. H. Golub and C. F. Van Loan, Matrix Computation, John Hopkins University Press, Baltimore, ML, 2013. 12
[23] http://www.image-net.org 13
[24] J. Deng, W. Dong, R. Socher, L. J. Li, K. Li, and L. Fei-Fei, “Imagenet: A large-scale hierarchical image database,” IEEE Conference on Computer Vision and Pattern Recognition (CVPR), Miami, Fla., USA, June 2009, 13

What is claimed:

1. A method for the optimization and design of CNN comprising: CNN Design and Optimization Theorem; Efficient Weights for CNN Design Theorem; and a practical way to make it slim.

2. The method of claim 1, wherein said CNN Design and Optimization Theorem comprises two criteria to make FC layers slim, namely, 1) rank criteria and 2) singular value criteria.

3. The method of claim 1, wherein said Efficient Weights for CNN Design Theorem comprises FC layer weights matrix W with colored Gaussian distribution being more efficient than that of white Gaussian.

4. The method of claim 2, wherein said rank criteria comprising that the said weight matrix should be of full rank for optimal design.

5. The method of claim 2, wherein said singular value criteria comprising that the singular values of said weight matrix (after optimization) should be maximized for given matrix size.

6. The method of claim 1, wherein said a practical way to make it slim comprising an SVD-QR approach for the said weight matrix.
